(19) United States
(12) Patent Application Publication
(10) Pub. No.: US 2010/0224743 A1
(43) Pub. Date: Sep. 9, 2010

(54) iCradle Portable Media Device Stand

(76) Inventor: William H. Carpenter, Severna Park, MD (US)

Correspondence Address: William H. Carpenter, Jr., 301 4th Street, Annapolis, MD, 21403, US

(21) Appl. No.: 12/398,853

(22) Filed: Mar. 5, 2009

(51) Int. Cl. F16M 11/22; F16M 11/04

(52) U.S. Cl. 248/176.1

(57) ABSTRACT

iCradle Portable Media Device Stand is a portable stand to be used with a portable media device as an accessory for the purposes of viewing any media content including video, listening to music, or utilizing any device-specific software application, hand-free while traveling, in the office, or at home. iCradle is designed to sit on a flat surface and hold a Portable Media Device in an optimal viewing angle. iCradle allows the device user to watch and listen to any media content, and utilize any software application comfortably while having complete freedom of movement with the hand(s). iCradle utilizes an angled placement slot to improve the viewing angle and reduce glares for comfortable viewing.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

Currently, Portable Media Devices, such as portable digital media players and mobile phones, are typically held in a Person's hand(s) to improve the viewing angle when being used for the purposes of watching media content, listening to music, or utilizing any device-specific software application. If used for an extended period of time, the described typical usage of a Portable Media Device becomes uncomfortable and cumbersome. At the same, the user's engaged hand(s) is made unproductive as it is holding on to the device. In addition, placing the device flatly on a flat surface changes the viewing angle in ways that distort the display quality and it can also create glares from the environmental lighting, making the viewing uncomfortable.

### BRIEF SUMMARY OF THE INVENTION

The invention titled, iCradle Portable Media Device Stand, is a portable stand to be used with a portable media device as an accessory for the purposes of viewing any media content including video, listening to music, or utilizing any device-specific software application, hand-free while traveling, in the office, or at home.

iCradle is designed to sit on a flat surface and hold a Portable Media Device in an optimal viewing angle. iCradle allows the device user to watch and listen to any media content, and utilize any software application comfortably while having complete freedom of movement with the hand(s). iCradle utilizes an angled placement slot to optimize the viewing angle and reduce glares for comfortable viewing.

### BRIEF DESCRIPTION OF THE DRAWINGS

FIG. 1 is a top view of the present invention.

FIG. 2 is a left side view of the present invention.

FIG. 3 is a right side view of the present invention.

FIG. 4 is a front view of the present invention.

FIG. 5 is a bottom view of the present invention.

FIG. 6 is an isometric view of the present invention.

FIG. I is a section view of the present invention with illustration of the placement slot angled at 22.5°.

### DETAILED DESCRIPTION OF THE INVENTION

The present invention is a stand to be used generally for portable media devices but not limited to digital media players and mobile phones. The present invention is applicable to other uses or applications.

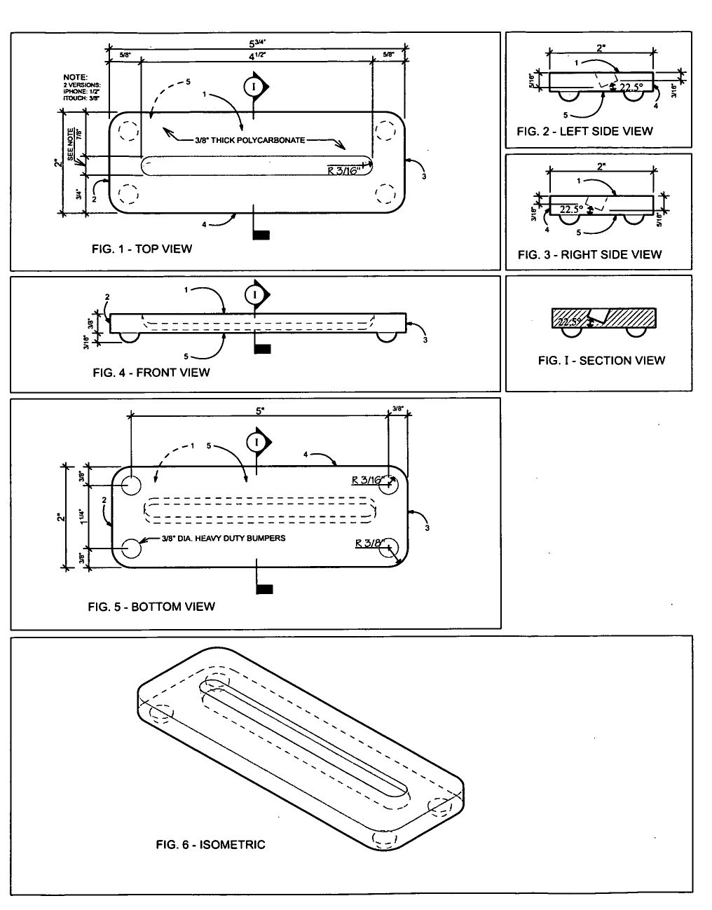

As illustrated in FIG. 1, the present invention 1 is a stand that holds a portable media device securely using the device's own weight. As further illustrated in FIG. 2, 3 and I, the portable media device is placed in the placement slot that is cut at an angle of 22.5° to optimize the viewing position and reduce glares. The four bumpers located in each corner on the bottom side of the present invention, as illustrated in FIG. 5, keeps the present invention from skidding. The present invention allows the User to comfortably multi-task with free use of his/her hands while enjoying the portable media device, instead of having to hold the device in his/her hand(s).

The manufacturing of the present invention utilizes a five-axis milling machine. A 4′×8′×⅜″ sheet of polycarbonate is divided into sections measuring 2″×5¾″. Each section will have the placement slot routed out at an angle of 22.5°, 4⅜″ wide and ¼″ deep. The routed placement slot will begin ⅝″ from the side and ¾″ from the front. With the cut being made ¾′ from the front side, the base provides the stability to hold the device at the appropriate angle without tipping over. Each corner of the piece will be radial-cut to ⅜″.

At that point, the present invention will be removed from the five-axis milling machine and the edges will be flame-polished.

After each piece has been polished and inspected, a ⅜″ heavy duty bumper will be applied to each corner in the bottom side of the present invention to keep the piece from skidding while in use.

1. The present invention titled, iCradle Portable Media Device Stand, is a portable stand that holds a portable media device, with the Stand comprising
a) a rectangular base that is both self-standing and weight-bearing, and lies on a flat surface;
b) an angled placement slot cut at 22.5° angle; and
c) four bumpers that prevent skidding.

2. iCradle Portable Device Stand of claim 1 wherein the self-standing and weight-bearing base stands and holds any portable media device securely using the device's own weight.

3. iCradle Portable Media Device Stand of claim 1 wherein the self-standing base allows the User to multi-task while using the present invention.

4. iCradle Portable Media Device Stand of claim 1 wherein the angled placement slot cut at 22.5° angle improves the viewing angle.

5. iCradle Portable Media Device Stand of claim 1 wherein the angled placement slot cut in 22.5° angle reduces glare from environmental light.

6. iCradle Portable Media Device Stand of claim 1 wherein the four bumpers create a non-skid surface on the invention to maintain the optimal viewing position.
